(19) United States
(12) Patent Application Publication
(10) Pub. No.: US 2010/0127875 A1
(43) Pub. Date: May 27, 2010

(54) RFID SYSTEMS

(76) Inventor: ALEX C.Y. WONG, CAMBRIDGE (GB)

Correspondence Address: DICKSTEIN SHAPIRO LLP, 1825 EYE STREET NW, Washington, DC, 20006-5403, US

(21) Appl. No.: 12/623,037

(22) Filed: Nov. 20, 2009

Related U.S. Application Data
(60) Provisional application No. 61/116,724, filed on Nov. 21, 2008.

(51) Int. Cl. H04Q 5/22; G08B 13/14; G08B 5/22

(52) U.S. Cl. 340/572.7; 340/10.34; 340/10.51; 340/825.49

(57) ABSTRACT

We describe an RFID communications network comprising: a plurality of passive RFID tags; at least one RF power supply device; and at least one RFID reader; and wherein a said RFID tag is configured to use a first frequency to receive power for powering said tag from said RF power supply device and to use a second, different frequency to communicate with said RFID reader; and wherein said plurality of RFID tags are configured to use the same said first frequency to receive said power, and all use different second frequencies to communicate with said RFID reader. The tags may be used to generate probability data, the probability data for a said identified tag being dependent upon a probability of the tag belonging to a collection the contents of which are to be verified; contents of the collection may then be verified against a schedule using processed verification data.

### FIELD OF THE INVENTION

The present invention relates to Radio Frequency Identification (RFID) systems and in particular i) to the addition of some advanced features of high cost active tags to a low cost passive tag; ii) where the environment is such that signals may be received from a range of tags, some of them being unwanted; and iii) techniques for locating product tags when a mobile or handheld tag reader is employed.

### BACKGROUND TO THE INVENTION

Background prior art can be found in: US2005/110636; WO01/95242; U.S. Pat. No. 5,838,235; U.S. Pat. No. 4,857,893; GB1290097; JP2007/067791; US2005/128055; WO2000/10144; US2007/0126634; GB2433178; WO2007/106972; US2007/188342; US2005/246092; JP2007/219736; and JP2006/221541.

RFID systems rely on radio frequency-based communication between a reader and a transponder or tag of various types for identifying objects and have a variety of applications. Categorically; there are two types of RFID tags: active and passive. An active tag carries its own power supply, typically a battery, to energize its internal electronic components. In contrast, a passive tag does not carry its own power supply, but relies on the RF field transmitted from a RFID reader to power its internal electronics.

In a typical arrangement of a passive RFID tag system according to prior art, a tag reader transmits an interrogating radio frequency signal that energises a tag within the range of a signal. Once a passive tag receives a RF power strong enough to drive its internal electronic components, it could interpret reader command and reply to the reader via a predefined protocol. The reader transmits a command to the tag by modulating the transmitted RF field. After transmitting the command, the reader continues transmitting a continuous wave (CW) to provide power for the tag to respond to the command. The tag sends data back to reader by altering its RF reflection features and the reader interprets data sent from a tag by anglicizing the reflected RF signal.

Both types of the RFID tags have their advantages/disadvantages, often on contrary/complementary to each other. Among them, an active tag has longer coverage range of up to 100 m, whereas a passive tag can only have coverage range from a few centimetres (13.5 MHz, for example) up to a few meters (UHF, for example). The main reason for a difference coverage range is because a passive tag has to absorb enough energy from the RF field transmitted from an interrogating reader. The further away is the reader, the less RF power a tag can receive for a given the same reader transmission power.

In terms of cost, an active tag is typically much higher compared to that of a passive tag. At the time of writing, the typical cost of an active tag is around $20 whereas a passive tag is in the order of $0.2, making it 100 times cheaper that its active counterpart. Furthermore, an active tag has theoretical lifetime limited by the battery life whereas a passive tag does not suffer that limitation. The difference in cost causes different application. Currently, active tags are used for low volume/high value items whereas the passive tags are justified for large volume/low value items due to lower costs.

In real industrial deployment, the use of passive tags is affected by several problems including deployment of tags in RF noisy environment, lower performance for high volume of tags in a given area etc.

FURTHER, in a typical supply chain, there are movement of goods in the form of pallets and its associated cases containing items of product. There are numerous identification numbers associated to these products, such as, but not limited to:
Pallet identification number (such as case SSCC)
Case identification number (such as case SSCC)
Delivery Notes
Shipment Identification number
Forwarder Identification Number
Sales Order generated by the supplier
Purchase Order from the end-users

These identification numbers are associated to each other with a particular relationship which is typically unique to each supply chain and its organisations. In most instances, an “Advanced Shipping Notice” or ASN containing information such as, but not limited to, pallets and cases identification numbers, delivery notes, departure dates, arrival dates etc will be sent from the “shipper” to the “receiver”—to notify the receiver in advance of the incoming deliveries of goods. This ASN message can be sent in a variety of ways, but the most common method is through an Electronic Data Interchange (or EDI).

In a traditional supply chain without Radio Frequency Identification (RFID), each shipment of pallets will be manually checked against some form of delivery notes containing the type of products (typically in the form of EAN or UCC barcodes) with the quantity being shipped. In such a way, the “receiver” is liable to check every single case and pallet against the delivery notes to legally ensure that the actual goods are being sent according to the paperwork.

In an RFID supply chain, pallets, cases, items and other associated physical entities can be tagged with RFID tags. These tags are then tracked to provide information tracking information about the group (or item) of product. The association of the product and related RFID information can be sent beforehand via ASN to the “receiver” to facilitate and automate the receiving process.

Broadly speaking one problem is how to match, at a stage in the supply chain, goods specified in an advance shipping notice with actual goods received, prior to passing the goods onto a subsequent party in the supply chain. This is a difficult problem because, broadly speaking, a tag merely provides a number or a set of numbers and in many environments, when a tag is read RFID signals from unwanted tags may erroneously be detected. More particularly, in the example of a tagged pallet, bearing tagged cases, storing tagged items there is considerable potential for confusion between signals from different pallets/cases/items.

ALSO determining the location of tagged items using mobile RFID reader is difficult as it is difficult to determine the exact location of the moving reader. This problem is even more challenging with UHF RFID system where the read zone of mobile RFID reader can go up to 2-3 metres range.

### SUMMARY OF THE INVENTION

Advanced Features

According to the invention there is therefore provided an RFID communications network, the network comprising: a plurality of passive RFID tags; at least one RF power supply device; and at least one RFID reader; and wherein a said RFID tag is configured to use a first frequency to receive power for powering said tag from said RF power supply device and to use a second, different frequency to communicate with said RFID reader; and wherein said plurality of RFID tags are configured to use the same said first frequency to receive said power, and one or both of different said second frequencies and different communication times to communicate with said RFID reader, a said second frequency being different to said first frequency.

Embodiments of the above invention address some particular problems arising with the use of multiple tags sufficiently close together for their signals to overlap. Embodiments of the invention also provide a significant range advantage. Embodiments of the invention are particularly useful, for example, where multiple tagged items are carried together, say on a common pallet. Embodiments of the invention combine advantages of both active and passive tags.

In some preferred embodiments of the RFID communications network a network controller is included to control the RF power supply device to power up and then to synchronise reading of one or more tags or selected tags. In some preferred embodiments the plurality of tags employ different read (second) frequencies. In embodiments the RF power supply device has one or more steerable antennas to selectively power the RFID tags.

In embodiments an RFID tag has two antennas, one for receiving power, and one for communicating. In some embodiments these comprise two frequencies within a single RF band, for example microwave, UHF, VHF, ISM or the like.

The invention also provides an RFID tag as described above.

The invention further provides a method of reading a plurality of RFID tags grouped in a common location, the method comprising using an RFID communications network as described above to power the tags and then to read the tags.

In embodiments of the above-described systems a tag is writable and the communications network and tag are configured for writing data to the tag. This is particularly advantageous as data writing tends to be particularly range-constrained and thus embodiments of the invention can provide particularly useful advantages.

Clutter Handling Techniques

According to the invention there is therefore provided a method of using an RFID system to verify the contents of a collection of entities, each said entity being tagged with an RFID tag, said RFID system operating in an environment with a plurality of said collections such that an RFID reader of said RFID system may read tags of entities belonging to multiple different said collections, the method comprising: providing schedule data identifying tagged entities which should be present within one or more said collections; reading identities of a plurality of said RFID tags within said operating environment to create verification data comprising identified tags; determining probability data for said identified tags, said probability data for a said identified tag being dependent upon a probability of the tag belonging to said collection said contents of which are to be verified; processing said verification data using said probability data; and verifying said contents of said collection against said schedule data using said processed verification data.

Preferably the processing comprises processing said verification data to de-weight identified tags which are not expected to belong to said collection said contents of which are to be verified, using said probability data. In embodiments it is preferable, but not essential, to specify the collection against which the processed verification data is to be checked (although potentially this may be deduced). The schedule data in itself provides information which is useful since it indicates what tags are expected in different collections. Thus in some preferred embodiments the determining of the probability data comprises comparing the verification data with the schedule data. For example the schedule data may be used to eliminate tags before using it to compare to determine whether or not the tags remaining are present—effectively “positive” elimination by determining whether a tag is known to be in a different collection. Alternatively the schedule data may be used in a negative way, to determine when an identified tag is not in a schedule to be verified.

In some preferred embodiments the RFID system is used to provide measurement data relating to the reading of a tag, and this is used to determine the probability data. For example the measurement data may include signal strength data such as RSSI (received signal strength data); data specifying whether a tag has previously been read or verified (in which case it may be known to be irrelevant); and/or data on a number of reads made to determine the identity of a tag may be employed (since a high number of reads per cycle may imply that the tag is at a long range). Broadly speaking a tag is determined to be at a long range is less likely to be relevant and more likely to be irrelevant (although given the nature of RF propagation this represents only a probability, not a certainty).

Still further, the determining of the probabilities may use data relating to a physical configuration of the RFID system, for example a transmit power level and/or data relation to a direction of one or more antennas of the RFID system—for example one antenna may point towards a collection of interest whereas another may point away from (or at least not as directly towards) a collection of interest.

In embodiments of the method processing the verification data to de-weight identified tags which are not expected to belong to the collection to be verified may comprise eliminating tags below a threshold of probability from a list to be compared with the schedule.

In some particularly preferred embodiments the schedule data comprises hierarchical data identifying hierarchical relationships between tags of the collection and tags of entities within a collection. A hierarchy such as this may have a number of levels, for example including groups of sub-entities. This information is useful because it may be employed to assign a probability to a tag as being in a collection. For example a tag may be given a higher probability of being in a collection if a number of other tags have been identified as being in the same collection. Additionally or alternatively, if one tag is found to have a higher probability of being located within a collection then a relatively higher probability may be associated with that collection when considering which other tags properly belong to the collection. Thus in preferred embodiments the schedule data is used to identify a collection of entities being read by the RFID system.

In some embodiments a collection may comprise a pallet or case, and the entities cases or items, respectively. In a three level hierarchy, pallets, cases and items may be tagged, and so forth.

In a further aspect the invention provides a computer system for using an RFID system to verify the contents of a collection of entities, each said entity being tagged with an RFID tag, said RFID system operating in an environment with a plurality of said collections such that an RFID reader of said RFID system may read tags of entities belonging to multiple different said collections, the computer system comprising: an input to receive schedule data identifying tagged entities which should be present within one or more said collections; an interface to said RFID system for receiving read identities of a plurality of said RFID tags within said operating environment to create a verification data comprising identified tags; a system to determine probability data for said identified tags, said probability data for a said identified tag being dependent upon a probability of the tag belonging to said collection said contents of which are to be verified; a system to process said verification data using said probability data; and an output to provide data verifying said contents of said collection against said schedule data using said processed verification data.

Mobile Reading

According to the invention there is therefore provided a method of determining a location of an RFID tagged product using a mobile RFID reader in an environment comprising a plurality of RFID tags and in which said RFID reader during a tag read event may detect signals from a plurality of different RFID tags, the method comprising: providing a plurality of RFID location tags; locating said tagged products in proximity to said RFID location tags; and reading an RFID tag of a said product and at least one said RFID location tag to determine a potential location of said product.

In some preferred embodiments the method further comprises distinguishing between a plurality of potential locations associated with a corresponding plurality of RFID location tags to determine a potential location of the product. This distinguishing in preferred embodiments comprises determining relative probabilities of the potential locations; these probabilities could be expressed in a binary fashion, for example to eliminate certain locations as possibilities, or as weights or percentage likelihoods.

A range of information may be employed to distinguish correct from incorrect locations, for example in embodiments data from the tag reader may be employed comprising one or more of a signal strength such as RSSI (Received Signal Strength Indication), a number of reads required to identify a tag, and data specifying whether a particular tag has previously been read. The latter may be particularly useful since this may be employed to rule out certain locations of a path if, say, a location has previously been assigned to the path and the user is still traversing the path. Another source of useful data for distinguishing between locations is the presence of one ore more previously determined pairings between an RFID tag of a product and a location of the product.

The determining of the relative probabilities may employ a defined, for example, user input, or learnt path of the mobile/hand-held RFID reader. If a path is known then likely confusing signals at points along the path may also be determined and hence identified as “distractors”.

In embodiments of the technique where a user traverses a path, the method may further comprise indicating to a user of the system when a location on the path has been missed.

In a related aspect the invention provides a computer system for determining a location of an RFID tagged product using a mobile RFID reader in an environment comprising a plurality of RFID tags and in which said RFID reader during a tag read event may detect signals from a plurality of different RFID tags, the computer system comprising: an interface to receive from said RFID reader (i) tag data from a plurality of RFID location tags locating said tagged products in proximity to said RFID location tags, and (ii) tag data from an RFID tag of a said product; and a system to use said tag data from said plurality of RFID location tags and said tag data from a said RFID tag of a said product to distinguish between a plurality of potential locations associated with a corresponding plurality of RFID location tags to determine a potential location of a said product.

The invention further provides computer program code for controlling a computer or computerized apparatus to implement a method or system as described above. The code may be provided on a carrier such as a disk, for example a CD- or DVD-ROM, or in programmed memory for example as Firmware. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

Features of the above described aspects and embodiments of the invention may be combined.

### BRIEF DESCRIPTION OF THE DRAWINGS

These and other aspects of the invention will now be further described, by way of example only, with reference to the accompanying figures in which:

FIG. 1 shows, schematically reader [symbol] tags communication: The reader (400) transmits RF waves (600), which can be un-modulated continuous form (CW) to provide energy for a group of tags (300, 310 and 320), or in modulated format to transmitted command to the tags; the tags (300, 310 and 320) reply to the reader (400) via defined protocols by altering its RF reflection features; the reader interprets the tag's data by analyzing the reflected portion of the RF wave (600);

FIG. 2 shows, schematically an embodiment of the invention: The tags (300, 310 and 320) can be energized by the RF waves (200) transmitted from a RF device (100); once energized, the tags (300, 310 and 320) can communicate with a RFID reader (400) as active tags, even in cases where the RF wave (600) is too weak to energize the passive tags (300, 310 and 320);

FIGS. 3a and 3b show, respectively, a schematic planned view of an RFID system reading tags on a plurality of pallets comprising a plurality of cases each comprising a plurality of tagged items, and a schematic side view of a pallet;

FIG. 4 shows an example of schedule data for an advanced shipping notice (ASN);

FIG. 5 shows a schematic illustration of a plurality of storage bins each with an associated location tag (Li), the bins holding tagged items;

FIG. 6 shows the diagram of FIG. 5, illustrating two example paths between the locations (P1, P2); and

FIG. 7 shows, schematically, four tagged items (I2, I3, I7, I13) and examples of corresponding location tags which may be detected in association with reading from the product tags.

### DETAILED DESCRIPTION AND PREFERRED EMBODIMENTS

Advanced Features

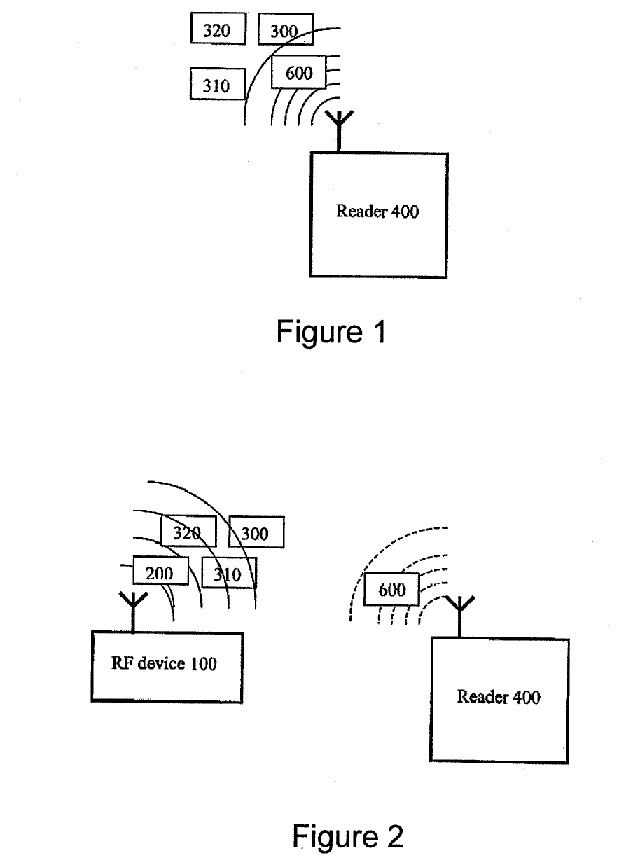

Embodiments of the invention relate to passive RFID tag(s) and its related peripheral devices. The tag communicates with conventional RFID readers following well-defined communication protocols. FIG. 1 illustrates this communication mode. Specifically, our passive tags (300, 310 and 320) are energised by the RF waves (600) transmitted from the conventional RFID reader (400), once the received RF power is beyond a predefined level. The reader sends command by modulating the RF (600) and the tags alternates their reflection features in replying the reader's request. In this respect the tags provide backward compatibility.

FIG. 2 illustrates the case of using RF waves (200) transmitted from other devices (100) to energise passive tags 300, 310 and 320). Once energised, the passive tags (300, 310 and 320) may communicate with the inquiring RFID reader (400) following data communication protocols, even if the RF power (600) received from the inquiring RFID reader is not enough to power up the tags. In this mode, the passive tags (300, 310 and 320) behave like active tags to the inquiring RFID reader, hence providing longer coverage distance with improved performance.

Furthermore, the RF device (100) may energize a number of tags simultaneously, which make embodiments of the invention useful for large volume itemized tagging.

Under high RF radiation noise, the efficiency of RF transmission would be poor as only a very small percentage of transmitted RF power is used by passive tags. Embodiments of the invention address this issue by moving the RF power supplier close to tags, hence, reducing the inefficiency of the RF over a longer transmitting distance.

In a complicated supply chain deployment scenario, the functional requirement of the tag may differ. In some cases, short range of communication is desired, but in other cases, long-range communication is preferred. Embodiments of the invention enable a passive tag to behave like an active tag when/where needed and vice versa. In addition to that, embodiments of the invention may follow standard communication protocols (such as EPCglobal Class 1 Gen2) and in this mode, a passive tag may be energised by the RF waves transmitted from the 1 reader additionally or alternatively to the RF power supply device.

However, passive tags we describe could be energised by RF waves transmitted from other devices and still be able to communicate with inquiring RFID readers. Once energised, a tag may communicate with other readers follow communication protocols, even if the RF power received from the communication reader is below the required limit to power up the tag due to the fact that the tag has already been energised by RF of another device.

As a result, embodiments of the invention provide flexibility by using a combined active/passive mode RFID tag. This further improves the efficiency of RF radiations.

Clutter Handling Techniques

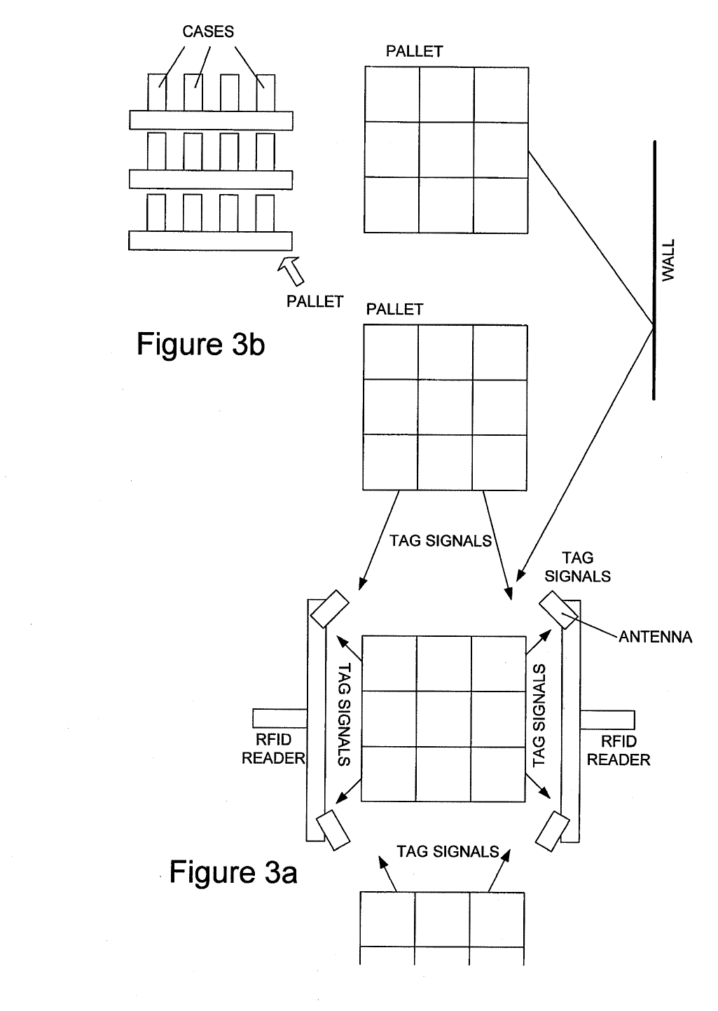

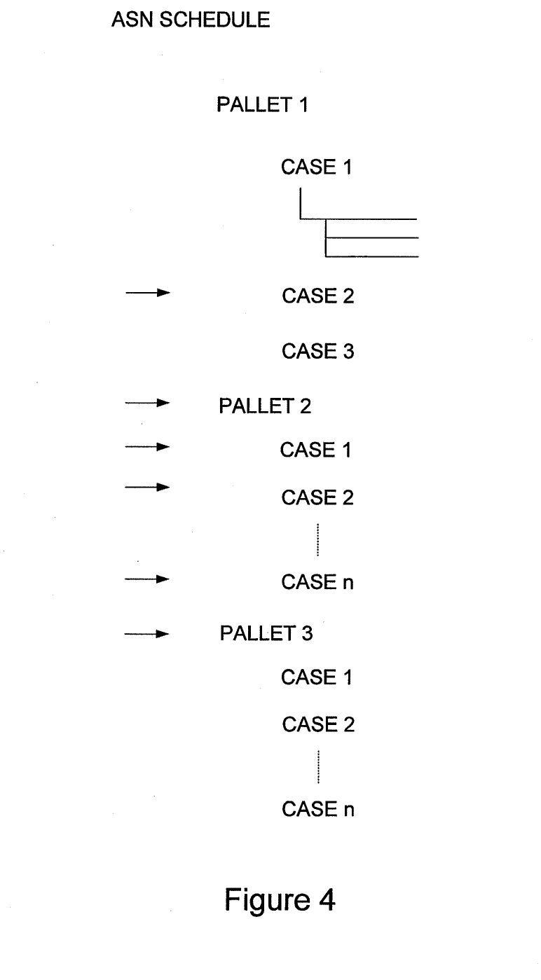

Referring to FIGS. 3 and 4, the process with RFID is as follows.

Step 1: The correct ASN is to be sent from the “Shipper” to the “Receiver” via EDI, Internet, e-mail or other communication channels. This ASN is automatically sent to the right Receiver by matching the delivery note with the purchase order of the “Receiver”.

Step 2: Once ASN is correctly received by the “Receiver”, the “Receiver” will check the ASN message for authenticity and content validity of the message using the appropriate methods (the methods of which is not defined here.)

Step 3: Once the message is “shipper” authenticated and the content validated, the “Receiver” will acknowledge the receipt of the ASN through appropriate communication channels back to the “shipper”—and this could be an optional process. Any inconsistency or errors in the ASN message could be sent back to the “Receiver” as well.

Step 4: Products usually physically arrive at the “Receiver” in groups of items and for illustration purposes, we assume that these products are grouped in cases and then in pallets. Each case will have an RFID tag, and a group of cases in a pallet will also be identified with a pallet RFID tag. There will be an “RFID portal”, i.e. an area whereby RFID readers and antennae are set up in such a way that it detects the presence of RFID tag(s) in that area.

Step 5: As soon as RFID tag(s) are detected by the RFID reader(s) via the antenna(e), a method or methods of identifying which group of product (in this illustration, the pallet) in the RFID portal zone is initiated. This method(s) is a set of probability algorithms that decide the which pallet is in the RFID zone using weighting of factors such as Reader Signal Strength Indicator (RSSI), number of reads of the tags for a given number of read cycles, orientation of antennae in the field, previous states of tags (for example, if there are a few portal zones that pallets need to go through in a particular sequence, then the next portal zones could “anticipated” a particular pallet sequence) and also using information from ASN such as hierarchy of items, cases and associated pallets. An alert could be sent to the relevant pre-determined staffs who are responsible for the relevant deliveries or shipments.

Step 6: Once the exact group of product is identified, a second method will eliminate “irrelevant tags” in the field, i.e. tags that are not part of the goods check-in process for that particular pallet. Note that the number of identified tags in the portal zone may be more than the group of product as indicated by the ASN—in which case these tags may be “irrelevant” tags (for example tags that belongs to another group of product that is awaiting goods check-in or those that have already been received in the storage room but not limited to these). A third method could be used to identify possible legitimate tags attached to the cases/items although they are not part of the ASN information—this could be automatically inferred by the system using previous tag observations for example or through a manual process. There may also be situations where there are less than the anticipated number of tags as indicated by the ASN—in which case it may be the case the tags could be damaged or that certain items or cases could be missing (we can deduce this by matching with the ASN).

Step 6: Whether manually aided or automatically checked-in by the “receiver”, once the group of products has been matched with the ASN, a receipt message could be sent back to the “Shipper” with all the relevant goods check-in information—and we call this the Acknowledged Receipt Notice (ARN).

In FIG. 4, an arrow (→) designates a signal received from a tag identifying the item (with the arrow) in the schedule. The probability of a tag, Prob(tag) is a function of, inter alia, the schedule, the received signal strength (RSSI), the configuration, whether there has been prior reception of the tag, ie. Prob(tag)=f(Schedule, RSSI, Configuration, Prior_Reception, . . . ).

We have thus described:

How ASN is sent to the right “receiver”.

Methods to authenticate the shipper ASN message.

Methods to validate the content of the message.

A method of alerting staffs of the arrival of new grouped deliveries.

A method of estimating the group of product in the portal zone.

A method of determining the “Irrelevant tags”.

A method of determining “irrelevant tags”.

A reciprocal ASN message to be sent back to the “Receiver”, called ARN.

Mobile Reading

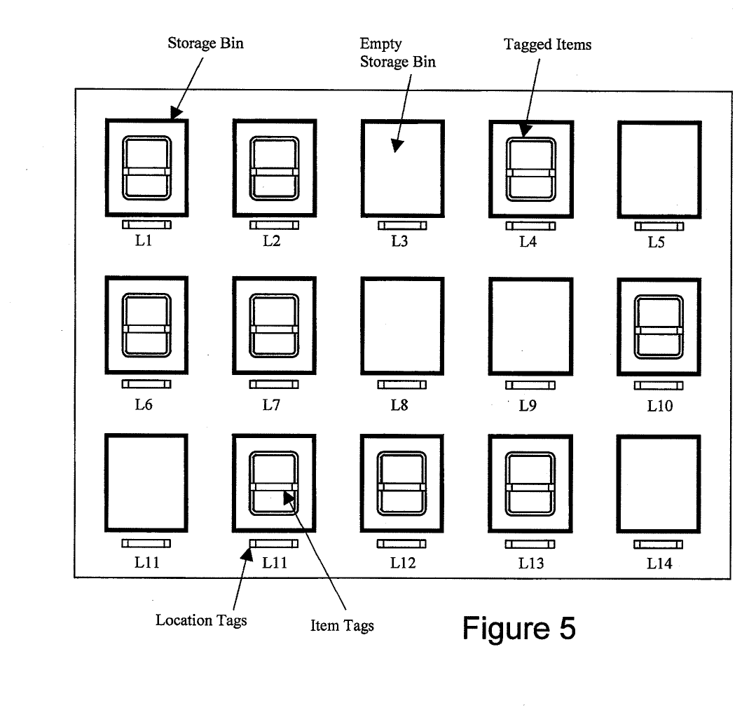

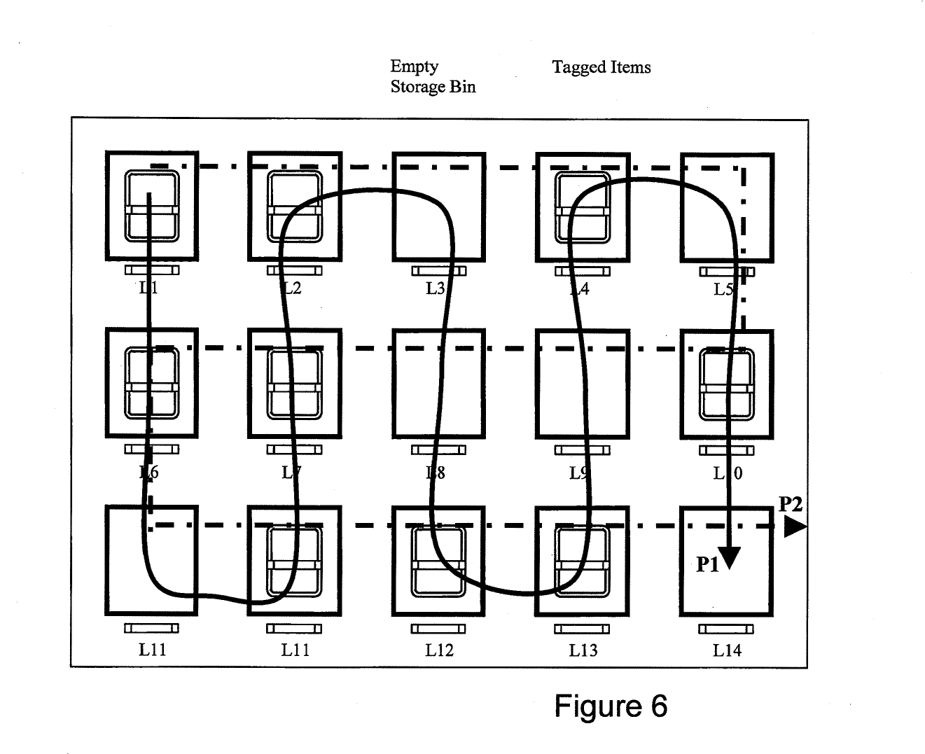

Referring to FIGS. 5-7, in embodiments there are two types of tags:
1. Item Tags—these tags are written with unique numbers and attached to relevant items in order to enable uniquely identification of those items using RFID. There will be a one-to-one association between the unique number and the item information stored somewhere in the database
2. Location Tags—these tags are written with unique numbers and attached to a particular location in order to uniquely identify those locations using an RFID system. The physical distance relationship between these location tags must be predefined in a system

With location tags, the movement of mobile RFID reader can be deduced by filtering for the location tags identification numbers with the predetermined tag locations in the system. For example, referring to FIG. 5, we chose an example of a bin storage system but the storage location may vary in shape and sizes (for example shelves in a warehouse, sections of areas on a flat floor etc). Each bin storage is given a location identification number L_{N} where N=1 to 14 written into the location tag T_{LN}. In some bins, there are item with item identification number I_{M} where M=1 to 9 written into item tag T_{IM} (as there are only nine item tags in the example diagram).

Step 1: A mobile RFID reader moving across the storage location will be continuously picking up RFID tag T_{LN} and T_{IM}.

Step 2: The mobile RFID reader may move based on different paths. As an illustration, in diagram 2, there are two possible paths as indicated by P1 and P2 (number of paths is theoretically infinite).

Step 3: Based on this, different location determination algorithms could be used to determine the location of tag T_{LN} in the storage bin.
If location of tag T_{LN} has been predefined in the system to location L_{N} (location L_{N} can be defined based on exact measurement relative to each other, or approximate locations), then the sequence in which T_{LN} appears (Other factors could also be considered to such as the time between T_{LN}, signal strength of the tags, previous RFID read results etc) will provide an indication for location L_{N} which subsequently provides an indication of the path of the mobile reader. Any item tags T_{IM} that are being read can then be approximated to the location L_{N}.
If location of tag T_{LN} has been not been predefined in the system to location L_{N}, then any tags T_{N} that are read could only have relationship with location tag T_{LN}, which could provide a reasonable indicator for users as to the approximate location of T_{IM} by visually finding the tag T_{LN}.

Step 4: If there are any location tags T_{LN} that are not read by the RFID reader, then the user could be prompted immediately to change the read path towards the missing location tags. This will ensure that all possible read zones are covered, and provide a higher chance for all the tag T_{IM} to be successfully read.

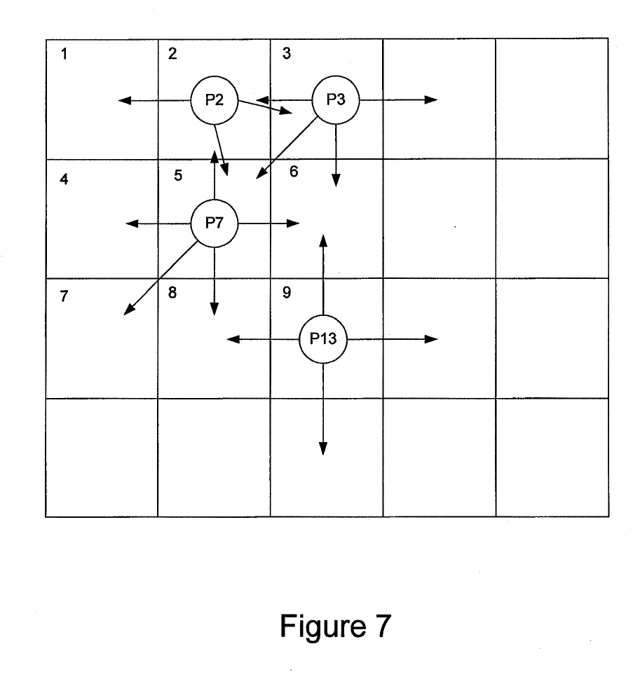

Referring to FIG. 7, the above can be represented as:

| | |
|---|---|
| P2: | 2, 1, 3, 5 |
| P7: | 5, 4, 2, 6, 7, 8 |
| P3: | 3, 2, 6, 5 |
| P13: | 9, 8, 6, . . . |

Thus we have described:

Methods of determining location of tagged items with and without location tags.

A method of determining which bins are not being scanned by the RFID reader based on location tags (and also prior knowledge of item tags read pattern). This includes considering factors such as sequence of location and item tags being read, the time between tag reads, signal strength of tags, previous states of relationships between item tags.

Methods of determining path of mobile RFID reader based on location tags. A method of indicating to the system or user in real-time to rescan a particular bin(s) based on the absence of location tags during the read cycle.

No doubt many other effective alternatives will occur to the skilled person. It will be understood that the invention is not limited to the described embodiments and encompasses modifications apparent to those skilled in the art lying within the spirit and scope of the claims appended hereto.

1. An RFID communications network, the network comprising:
a plurality of passive RFID tags;
at least one RF power supply device; and
at least one RFID reader; and
wherein a said RFID tag is configured to use a first frequency to receive power for powering said tag from said RF power supply device and to use a second, different frequency to communicate with said RFID reader; and
wherein said plurality of RFID tags are configured to use the same said first frequency to receive said power, and one or both of different said second frequencies and different communication times to communicate with said RFID reader, a said second frequency being different to said first frequency.

2. An RFID communications network as claimed in claim 1 wherein said plurality of RFID tags are configured to use different said second frequencies and further comprising a network controller coupled to control said RF power supply device and to said RFID reader, and configured to synchronise powering of said RFID tag and reading of a said tag.

3. (canceled)

4. An RFID communications network as claimed in claim 1 wherein said at least one RF power supply device has a steerable antenna to selectively power said RFID tags and wherein a said RFID tag has two antennas, one for said first frequency and one for said second frequency.

5. (canceled)

6. An RFID communications network as claimed in claim 1 wherein said first and second frequencies comprise two frequencies within a single RF band and wherein said RF band comprises a UHF band.

7. (canceled)

8. An RFID tag for the RFID communications network of claim 1, wherein said RFID tag is configured to use a first frequency to receive power for powering said tag from said RF power supply device and to use a second different frequency to communicate with said RFID reader and wherein said RFID tag is a writable tag, and wherein said RFID communications network is configured for writing data to said tag.

9. (canceled)

10. An RFID communications network as claimed in claim 1 including a computer system for determining a location of an RFID tagged product using a mobile RFID reader in an environment comprising a plurality of RFID tags and in which said RFID reader during a tag read event may detect signals from a plurality of different RFID tags, the computer system comprising:
an interface to receive from said RFID reader (i) tag data from a plurality of RFID location tags locating said tagged products in proximity to said RFID location tags, and (ii) tag data from an RFID tag of a said product; and
a system to use said tag data from said plurality of RFID location tags and said tag data from a said RFID tag of a said product to distinguish between a plurality of potential locations associated with a corresponding plurality of RFID location tags to determine a potential location of a said product.

11. An RFID communications network as claimed in claim 1 including a computer system for using an RFID system to verify the contents of a collection of entities, each said entity being tagged with an RFID tag, said RFID system operating in an environment with a plurality of said collections such that an RFID reader of said RFID system may read tags of entities belonging to multiple different said collections, the computer system comprising:
an input to receive schedule data identifying tagged entities which should be present within one or more said collections;
an interface to said RFID system for receiving read identities of a plurality of said RFID tags within said operating environment to create a verification data comprising identified tags;
a system to determine probability data for said identified tags, said probability data for a said identified tag being dependent upon a probability of the tag belonging to said collection said contents of which are to be verified;
a system to process said verification data using said probability data; and
an output to provide data verifying said contents of said collection against said schedule data using said processed verification data and
wherein said system to process said verification data using said probability data comprises a system to de-weight identified tags which are not expected to belong to said collection said contents of which are to be verified, using said probability data.

12. (canceled)

13. (canceled)

14. (canceled)

15. (canceled)

16. A method of determining a location of an RFID tagged product using a mobile RFID reader in an environment comprising a plurality of RFID tags and in which said RFID reader during a tag read event may detect signals from a plurality of different RFID tags, the method comprising:
providing a plurality of RFID location tags;
locating said tagged products in proximity to said RFID location tags; and
reading an RFID tag of a said product and at least one said RFID location tag to determine a potential location of said product.

17. A method as claimed in claim 16 further comprising distinguishing between a plurality of said potential locations associated with a corresponding plurality of RFID location tags to determine said potential location of said product and further comprising determining relative probabilities of said plurality of potential locations, and wherein said distinguishing is responsive to said determined probabilities.

18. (canceled)

19. A method as claimed in claim 17 wherein determining of said relative probabilities is responsive to a time between reading of RFID tags in successive said potential locations.

20. A method as claimed in claim 17 wherein determining of said relative probabilities is responsive to data from said tag reader, said data relating to said tag reading and wherein said data relating to said tag reading comprises one or more of data specifying if a tag has previously been read, signal strength data, and data on a number of reads made to determine a said identity of an RFID tag.

21. (canceled)

22. A method as claimed in claim 17 wherein said distinguishing is responsive to one or more previously determined pairings between a said RFID tag of a said product and a location of the product.

23. A method as claimed in claim 17 wherein said distinguishing is responsive to a defined or learnt path of said mobile RFID reader and further comprising indicating to a user of said RFID system when a location on a said path has been missed.

24. A method as claimed in claim 16, the method using an RFID system to verify the contents of a collection of entities, each said entity being tagged with an RFID tag, said RFID system operating in an environment with a plurality of said collections such that an RFID reader of said RFID system may read tags of entities belonging to multiple different said collections, the method comprising:
providing schedule data identifying tagged entities which should be present within one or more said collections;
reading identities of a plurality of said RFID tags within said operating environment to create verification data comprising identified tags;
determining probability data for said identified tags, said probability data for a said identified tag being dependent upon a probability of the tag belonging to said collection said contents of which are to be verified;
processing said verification data using said probability data; and
verifying said contents of said collection against said schedule data using said processed verification data.

25. A method as claimed in claim 24 wherein said processing of said verification data comprises:
processing said verification data to de-weight identified tags which are not expected to belong to said collection said contents of which are to be verified, using said probability data and
wherein said determining of said probability data comprises comparing said verification data with said schedule data.

26. (canceled)

27. A method as claimed in claim 24 further comprising using said RFID systems to provide measurement data relating to said reading of said identities of said RFID tags, and wherein said determining of said probability data uses said measurement data.

28. A method as claimed in claim 27 wherein said measurement data includes one or more of signal strength data, data specifying if a tag has previously been read and data on a number of reads made to determine a said identity of an RFID tag.

29. (canceled)

30. (canceled)

31. A method as claimed in claim 24 wherein said determining of said probability data uses data relating to a configuration of said RFID system and said configuration comprises data relating to a direction of one or more antennas of said RFID system.

32. (canceled)

33. A method as claimed in claim 24 wherein said processing of said verification data to de-weight identified tags comprises eliminating from said verification data identified tags which are not expected to belong to said collection said contents of which are to be verified, and wherein said verifying comprises comparing said schedule data and said processed verification data.

34. A method as claimed in claim 24 wherein each said collection is tagged with a said RFID tag, and wherein said schedule data comprises hierarchical data identifying hierarchical relationships between tags of said collections and tags of said entities and wherein said determining of said probability data comprises using said hierarchical data to assign a probability to an identified tag being in a collection dependent on the number of other tags identified as being in the collection.

35. (canceled)

36. A method as claimed in claim 34 further comprising using said schedule data to identify a said collection of entities being read by said RFID system and wherein a said collection comprises a pallet or case respectively, and wherein said entities comprise cases or items respectively.

37. (canceled)

38. (canceled)
